(19) United States
(12) Patent Application Publication
(10) Pub. No.: US 2013/0209818 A1
(43) Pub. Date: Aug. 15, 2013

(54) LIGHT REFLECTIVE, SELF-ASSEMBLING BLOCK COPOLYMER FILM OR COATING, METHODS FOR THEIR PREPARATION AND USE THEREOF

(71) Applicants: John Patrick Anthony Fairclough, South Yorkshire (GB); Andrew Pryke, South Yorkshire (GB); Nadejda Tzokova, South Yorkshire (GB); Andrew Parnell, South Yorkshire (GB); Oleksandr Mykhaylyk, Sheffield (GB)

(72) Inventors: John Patrick Anthony Fairclough, South Yorkshire (GB); Andrew Pryke, South Yorkshire (GB); Nadejda Tzokova, South Yorkshire (GB); Andrew Parnell, South Yorkshire (GB); Oleksandr Mykhaylyk, Sheffield (GB)

(21) Appl. No.: 13/812,174

(22) PCT Filed: Aug. 5, 2011
(86) PCT No.: PCT/GB2011/051491

§ 371 Date: Apr. 2, 2013

(30) Foreign Application Priority Data
Aug. 6, 2010 (GB) 1013274.4

(51) Int. Cl. G02B 5/28; B05D 5/06; G01N 21/25

(52) U.S. Cl. CPC G02B 5/281; G01N 21/25; B05D 5/06
USPC 428/517; 356/36; 428/516; 428/518; 252/582; 427/162; 427/8

(57) ABSTRACT

A multilayer light reflective self assembly film or coating which reflects light of a desired wavelength is obtained by blending block copolymer fractions of different molecular weight. The colour of light reflected by the film or coating depends on the relative amounts of the block copolymers in the blend. Thus, the colour of the reflected light is selectable by varying the relative amounts of the block copolymers in the blend. The polymers may be cross-linked by means of a suitable cross-linking agent. Applications of the film or coating include anti-counterfeiting devices.

### FIELD OF THE INVENTION

This invention relates to block copolymer compositions, and more particularly to blends of block copolymers, typically in the form of films, film-forming compositions comprising such block copolymer blends, methods for manufacturing such compositions and films, and their uses, for example, in currency and document protection, optical filters, fibre optics and transmissive and reflective coatings. In variations and embodiments of the invention the blends of block copolymers can be additionally blended with cross-linking systems or agents, typically di- tri- or multi-functional materials, such as acrylates, commonly used in printing processes to create a colour shift ink.

### BACKGROUND TO THE INVENTION

Interference filters have been known for many years (see, for example, U.S. Pat. No. 2,590,906). A typical interference filter has a largely reflective metal film on a smooth substrate. The reflective film is overlain by a thin layer of transparent dielectric material, more often a dielectric stack. This stack comprises alternating layers of dielectric material, with differing refractive indices. The filter is completed by a semi-reflective metal layer over the dielectric material. A transparent protective coating may be applied over the reflective coating, but does not form part of the interference filter itself.

When an incident light beam encounters the front semi-reflective coating of the interference filter, one fraction of the light is reflected and the other fraction passes through the semi-reflective layer into the dielectric material. The transmitted portion of the beam is then again partially reflected by the next reflective layer and retransmitted through the dielectric layer. This continues through the stack. The reflected waves pass through the semi-reflective front layer where they may constructively or destructively interfere with the reflected light, resulting in the generation of colour.

The interlayer separation or “d-spacing” (see FIG. 7) of the dielectric material is a whole multiple of quarter wavelengths of light for constructive interference (conditional on the index of refraction of the dielectric materials). Thus, when light is reflected from the interference filter, light with the appropriate wavelength has the reflected and transmitted beams in phase for constructive interference. Light of other colours has at least partial destructive interference. Thus, when a reflective interference filter is observed in white light, it reflects a characteristic colour.

Interest has developed in recent years in the protection of currency and other documents from counterfeiting by use of interference filters. The colour variations available from interference filters cannot be duplicated by copying machines and the specialized equipment needed for producing the interference filters is not readily available to counterfeiters. Thus, it has been proposed to mark currency with multicoloured interference filter patterns to inhibit counterfeiting (see, for example, U.S. Pat. No. 5,009,486).

The interference filter has a desirable characteristic as an anti-counterfeiting measure. The colour reflected from the filter depends on the path length of light passing through the dielectric material. When the filter is observed with light at normal incidence, a certain colour, for example red, is seen. When the interference filter is observed at an angle nearer grazing incidence, a shorter wavelength colour, for example, blue, is observed. Such a characteristic change of colour, depending on the angle of viewing the interference filter, cannot be reproduced by copying machines.

The original interference filters used inorganic optical coating materials, such as those listed in U.S. Pat. No. 5,009,486. A layer of such material is deposited with a certain thickness. A mask is superimposed and a second layer of that material is deposited over a portion of the first layer. Collectively, these two layers define areas of differing thicknesses and hence, different interference colours.

Such a technique is costly. The metal and dielectric layers are typically deposited on a thin film polyester substrate by a sputtering technique at a rate of about 3 to 10 metres per minute movement of the film past the deposition stations. Much faster deposition is desirable. Furthermore, two separate deposition steps with intervening masking of the surface must be performed to provide the two layers of dielectric which collectively provide a colour difference.

In U.S. Pat. No. 6,264,747 there is described a multi-colour interference polymer material coating for a transparent or opaque substrate. The coating material is an acrylate polymer and different colours are obtained by having different thicknesses of transparent coating in adjacent areas. The coating is deposited by evaporation of acrylate monomer, which requires specialized equipment, and the process of depositing different thicknesses in different areas is difficult to control.

The use of multilayer reflection films comprising alternating layers of two or more polymers to reflect light is known and is described, for example, in U.S. Pat. No. 3,711,176, U.S. Pat. No. 5,103,337, WO 96/19347 and WO 95/17303. U.S. Pat. No. 6,797,366 describes a multilayer polymeric film characterized by a change in colour as a function of viewing angle.

Block copolymers made up of incompatible segments will spontaneously self-assemble into well ordered microphase separated structures that possess defined length scales under the appropriate conditions. These materials have generated huge interest as materials for a variety of applications due to their ability to self-assemble into an array of 1D, 2D, and 3D periodic structures whose length scales can simply be controlled thorough judicious choice of molecular weight and volume fraction¹⁻⁵. The principal advantages over conventional inorganic systems are their large area fabrication potential² and low overall cost. Several authors^{6, 7} have reported block copolymers as having potential uses as photonic structures suitable for optical devices, due to the high level of ordering. Such structures have potential applications in elements of displays and telecommunication devices, as filters and waveguides in the visible and near infra-red wavelengths.

WO 2006/103462 describes a multilayer, light reflective, variable interlayer separation, cross-linked self-assembling block copolymer film or coating wherein a property of the reflected light can be changed by varying the interlayer separation of the film or coating. The interlayer separation is changed by treating the film or coating with a substance which causes swelling of the block copolymer, such as a suitable solvent.

One of the principal problems with block copolymer materials is that the properties of these self-assembled nanostructures are determined by the intrinsic physical polymer properties i.e. molecular weight, M_{w} and volume fraction, φ. The interactions between the blocks A and B of a copolymer are characterized by the Flory-Huggins interaction parameter⁸, X_{AB} and the total number of segments N_{A}+N_{B}. Depending on the composition of the block copolymers, microphase-separated block copolymers can form numerous morphologies. However, the inconvenience and expense of synthesizing one particular block copolymer for each specific nanostructure, and hence range of colour shift, makes these materials commercially unattractive. Research has already shown that for lamellar structures these domains can be swollen by the addition of homopolymers, but this approach is severely limited by the unbinding process and after the lamellae have swollen by 20% there is an increase in the distribution of lamellae thickness after which the transmission peak becomes very broad⁹.

Hashimoto et al¹⁰ found a region in composition where a single lamellae domain is formed from a mixture of two low molecular weight symmetric block copolymers with a ratio in the molecular weights of less than 5. Above this molecular weight ratio the system forms two macroscopically phase separated lamellae domains. A theoretical study of the stability of a single lamellae domain from a mixture of two block copolymers was carried out by Matsen, using self-consistent field theory (SOFT). Matsen examined the miscibility of two lamellar forming AB block copolymers with differing polymerization indexes. He found that if symmetric diblock copolymers differ in molecular weight by less than a factor of 5, then they will form a single lamellar phase and that will be completely miscible¹¹.

### BRIEF SUMMARY OF THE INVENTION

In some embodiments present disclosure outlines a method for preparing a one-dimensional Bragg stack with a selectable wavelength from a range that encompasses the entire visible spectrum and into the infra-red region. The wavelength selection is achieved by the blending of two or more block copolymers. Typically, the lowest molecular weight polymer of the block copolymers has a molecular weight of at least 300,000 g mol⁻¹, for example at least 350,000 g mol⁻¹, 400,000 g mol⁻¹, 450,000 g mol⁻¹ or 500,000 g mol⁻¹, in particular about 550,000 g mol⁻¹ or more such as 600,000 g mol⁻¹, 650,000 g mol⁻¹, 700,000 g mol⁻¹, or 750,000 g mol⁻¹. Typically, the highest molecular weight polymer of the block copolymers has a molecular weight of at least 700,000 g mol⁻¹, for example at least 750,000 g mol⁻¹, 800,000 g mol⁻¹, 850,000 g mol⁻¹ or 900,000 g mol⁻¹, in particular about 950,000 g mol⁻¹ or more such as 1,000,000 g mol⁻¹, 1,050,000 g mol⁻¹, 1,100,000 g mol⁻¹, or 1,150,000 g mol⁻¹. In one notable example, for visible wavelengths, the block copolymers are 562,000 g mol⁻¹ and 988,000 g mol⁻¹ poly(styrene-isoprene) (PS-b-PI) diblock copolymers. The block copolymers may preferably be symmetric block copolymers. The block copolymer must comprise blocks which differ in the refractive index of the constituent polymer blocks.

The ability to selectively choose a specific wavelength by the blending of two or more block copolymers allows for the design of lamellar Bragg mirrors with well-defined optical properties.

The inventors' findings demonstrate a simple and cost-effective way of obtaining a highly selective and narrow filter that can be blended on demand for a diverse range of applications. This overcomes a significant problem in block copolymer photonics, that each individual block copolymer has its own intrinsic wavelength when formed into a Bragg stack with the consequence that a different (bespoke) block copolymer is required for each desired wavelength of reflected light. The ability to tune the wavelength over the full visible wavelength range by blending as few as two block copolymers, and optionally three, four, five or more block copolymers, opens up many opportunities for optical components, including filters that span the UV, visible and infrared region of the spectrum. The inventors expect this route to have many applications for displays and filters.

In an advantageous development of the invention the block co-polymers may be cross-linked, before or after application to a substrate. A typical cross-linking agent is a di-, tri- or multi-functional molecule suitable for reacting with more than one polymer chain. The choice of cross-linking agent is determined in accordance with the selected block copolymers and a person skilled in the art will recognise suitable cross-linking agents for particular polymers or polymer combinations. For the polystyrene-isoprene exemplified herein, acrylates will typically form a suitable cross linking agent. In preferred formulations, an in initiation step is required to effect the cross-linking, such as exposure to u.v. light. Thus the blends of polymers according to the invention can be prepared as an ink suitable for application to a substrate. The ink is cross-linked such as by irradiation with u.v. light after application to the substrate thereby to achieve a stable polymer film.

### STATEMENTS OF INVENTION

According to a first aspect of the present disclosure there is provided a multilayer light reflective, self-assembling block copolymer film or coating comprising a blend of block copolymers of different molecular weight wherein a property of the reflected light is determined by the relative proportions of the respective block copolymers in the blend.

Preferably the blend comprises two block copolymers.

Preferably in the blend at least one of the block copolymers is a diblock copolymer.

In embodiments of the disclosure two of more of the block copolymers may preferably be diblock copolymers.

In some preferred embodiments, all of the block copolymers are diblock copolymers.

In some preferred embodiments, the blend consists of two diblock copolymers.

In preferred embodiments said property of the reflected light is colour.

Preferably the wavelength of the reflected light is selectable in accordance with the relative proportions of the respective block copolymers in the blend from a wavelength range of about 400 nm to about 850 nm,

In particularly preferred embodiments, for each block copolymer, a first polymer block constituent of the block copolymer differs in refractive index from a second polymer block constituent of that block copolymer

In some preferred embodiments the block copolymer is selected from block copolymers of C₁₋₆ aliphatic monomers, dienes, C₈₋₁₂ aromatic monomers, block copolymers of polyolefins with vinyl polymers derived from C₁₋₆ aliphatic esters, alcohols, and amines, C₁₋₆ alkylene oxides, and C₇₋₁₂ heterocyclic monomers.

In some particularly preferred embodiments the block copolymer is selected from block copolymers of styrene with methylmethacrylate P(S-b-MMA), isoprene P(S-b-I), butadiene P(S-b-BD), ethylene oxide P(S-b-PEO) and 2-vinylpyridine P(S-b-2-VP), or blends thereof.

Preferably the block copolymer blend has an optical domain spacing λ, within the range defined by 400 nm<λ<800 nm for visible wavelengths, where λ=2(n₁d₁+n₂d₂), n₁ and n₂ are the refractive indexes of the polymers and d₁ and d₂ are the thicknesses of the domains which make up one lamellar period.

Preferably the molecular weights of the respective block copolymers differ by less than a factor of about 10, more particularly the molecular weights of the respective block copolymers differ by less than a factor of about 5 and especially the molecular weights of the respective block copolymers differ by less than a factor of about 2.

In preferred embodiments the film or coating comprises a single lamellar structure substantially without macrophase separation.

Preferably the film or coating is semi-transparent. In this way the colour shift is observed as a variable colour tint.

In some preferred embodiments the copolymers comprising the blend are cross-linked. The cross-linking agent may be mixed with the polymer blend and a suitable solvent to form a printing ink.

According to a second aspect of the disclosure there is provided a substrate having deposited thereon a copolymer film or coating according to the first aspect of the disclosure or any of the embodiments or variations thereof, individually or in permitted combinations.

According to a third aspect of the disclosure there is provided a method of preparing a multilayer light reflective, self-assembling block copolymer film or coating which reflects light at a desired selected wavelength, the method comprising blending first and second block copolymers said block copolymers having different molecular weights and the relative proportions of said block copolymers in the blend being selected in accordance with the desired wavelength of reflected or transmitted light.

According to a fourth aspect of the disclosure there is provided a method of applying an anti-counterfeiting device to an article or substrate, the method comprising applying to the article or substrate a composition comprising a blend of self-assembling block copolymers of different molecular weight and forming a multilayer light reflective coating or film comprising said blend on the article or substrate, wherein a property of the reflected light is determined by the relative proportions of the respective block copolymers in the blend. Preferably the copolymer blend is a blend as defined in the first aspect of the disclosure or in any embodiment or variation thereof, individually or in any permitted combination.

In preferred embodiments the copolymer blend further comprises a cross-linking agent, the method further comprising initiating cross-linking of the copolymers of the blend by the cross-linking agent. The cross-linking agent may be mixed with the polymer blend and a suitable solvent to form a printing ink. Cross-linking is preferably effected after application of the blend to the substrate.

According to a fifth aspect of the disclosure there is provided an anti-counterfeiting ink composition or ink-type composition for application to an article or substrate to form a film or coating thereon, the composition comprising a blend of two or more block copolymers, the respective block copolymers being of different molecular weight, the relative amounts of the respective block copolymers in the blend being selected such that the resulting film or coating reflects light of a desired colour.

Preferably the copolymer blend is a blend as defined in the first aspect of the disclosure or in any embodiment or variation thereof, individually or in permitted combinations.

Preferably said composition further comprises a cross-linking agent effective to cross-link the polymers.

According to a sixth aspect of the disclosure there is provided a method of determining the colour of light reflected by a light reflective, self assembling block copolymer film or coating comprising a blend of block copolymers, the method comprising preparing a coating mixture comprising a selected blend of two or more block copolymers suitable for forming a said coating;
applying the coating mixture to a substrate to form a said light reflective, self assembling block copolymer film or coating thereon, directing white light at the coating, determining the colour of light reflected by the coating, and recording in human or machine readable format data sufficient to identify the determined colour, in association with the composition of the selected copolymer blend.

Preferably the method of the sixth aspect further comprises the steps of measuring the angle of incidence of light directed at the coating and recording said angle of incidence in association with the measured colour and the composition of the selected polymer blend.

According to a seventh aspect of the disclosure there is provided a method of constructing a library or database of the colour of light reflected by each of a plurality of light reflective, self assembling block copolymer films or coatings comprising a blend of block copolymers the method comprising executing the steps of the sixth aspect for a plurality of different block copolymer blends and recording data sufficient to identify the determined colour and composition of each respective blend in a library or database.

The method of the seventh aspect may further comprise the step of recording in said library or database the angle of incidence of light directed at the coating.

According to an eighth aspect of the disclosure there is provided a method of preparing a light reflective, self-assembling block copolymer film or coating comprising a blend of block copolymers configured to reflect light of a desired colour, the method comprising interrogating a library or database prepared as defined in the seventh aspect and identifying a composition of a copolymer blend associated with said desired colour, preparing a copolymer blend according to said identified blend, and applying said copolymer blend to a substrate to form said coating.

### BRIEF DESCRIPTION OF THE DRAWINGS

For a better understanding of the invention and to show how the same may be carried into effect, reference will be made, by way of example only, to the following Figures, in which:

FIG. 1(a) is a photograph of the blend series from the pure PS-PI 562K Mw (“562 k BCP”) solution on the left to the pure PS-PI 988K Mw (“988 k BCP”) solution on the right showing the change in colour with blend composition;

FIGS. 1(b) and 1(c) are the transmission spectra for the PS-PI diblocks for the pure diblock and the binary diblock blend compositions as a function of the wavelength (b) and in energy units (eV) (c);

FIG. 2 shows peak wavelength and lamella period as determined from the small angle x-ray measurements. FIG. 2a, shows the correlation of the domain spacing with the peak optical wavelength and FIG. 2b has the domain spacing and peak wavelength as a function of the average molecular weight of the blend;

FIG. 3 shows 1H NMR data for the fractionated diblocks of PS-PI polymer. The left hand spectrum shows a 37% Styrene, 63% Isoprene polymer and the right hand spectrum shows a 54% Styrene 46% Isoprene polymer. This indicates that there is a wide tolerance in the volume fractions suitable for blending to create the aforementioned effect.

FIG. 4 shows GPC chromatogram data for the fractionated diblock copolymers;

FIG. 5 shows a peak fitted to a Lorentzian function for the PS-PI 562K Mw solution. The example peak fitted to a Lorentzian function has a full width half maximum (FWHM) of 8.8 nm;

FIG. 6 shows the change in the full width half maximum as a function of blend composition; and

FIG. 7 shows the interlayer separation or “domain (d)-spacing” of a lamella structure dielectric material. Here only four layers are shown although in practice many more layers would usually be present.

### EXAMPLES AND METHODS

### Synthesis of Polystyrene-Polyisoprene (PS-PI) Polymers

PS-PI polymers were synthesized using high vacuum anionic techniques^{12,13}.

Analysis of two diblock copolymer fractions obtained was carried out by Gel Permeation Chromatography (GPC) and ¹H NMR. The ¹H NMR was performed in deuterated chloroform, CDCl₃. The GPC data gave a molecular weight of 988 k and 562 k for the two diblock copolymer fractions used for the subsequent blending study. These fractions are referred to herein as 988 k BCP and 562 k BCP respectively.

The two polymers were dissolved in o-xylene at 10% by weight and shear ordered between thin glass coverslips using manual oscillatory shear. The resulting lamellar domain was studied optically in transmission. The domain spacing and orientation was studied with small angle X-ray scattering (SAXS).

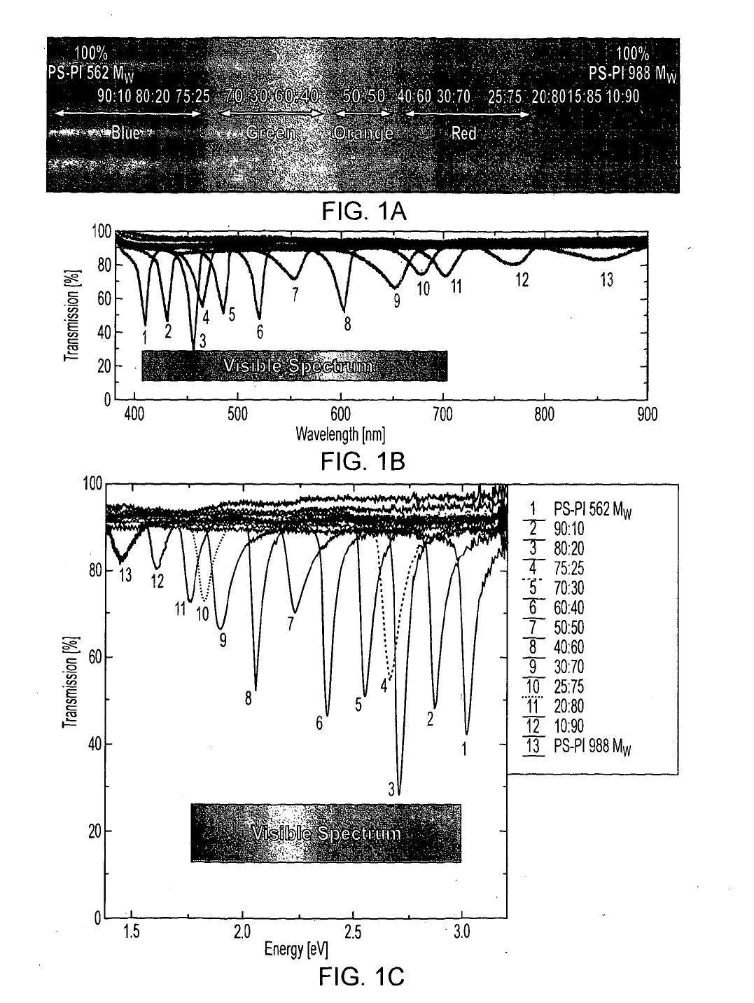

A series of binary blends of the two diblock copolymers was prepared in which the composition was varied from pure 562 k BCP to pure 988 k BCP. FIG. 1(a) shows a photograph (seen under reflected light) of the shear ordered blend series made using the two diblocks 562K BCP and 988 k BCP. As the composition of the blend is changed a gradual shift in the colour of the shear ordered layers with mixture composition is seen. The colour of the mixtures in FIG. 1(a) is due to the internal structure of the sheared blend solutions reflecting a narrow and well defined distribution of wavelengths. From left (which corresponds to 100% 562 k BCP) to right (which corresponds to 100% 988 k BCP) the colour changes from colourless through blue to red and back to colourless.

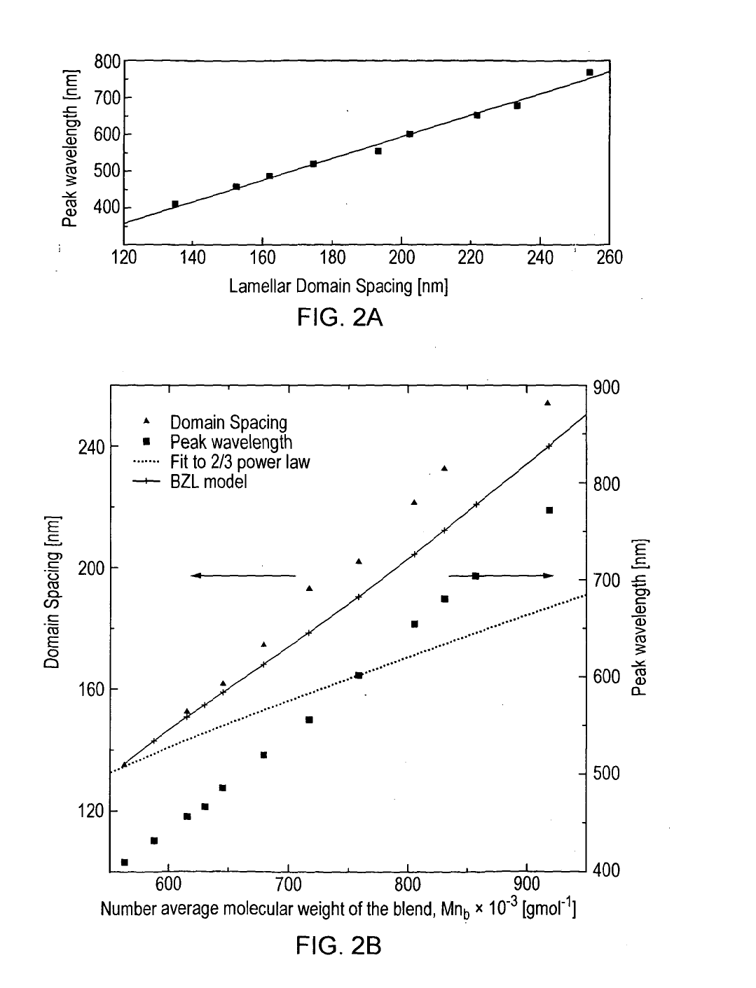

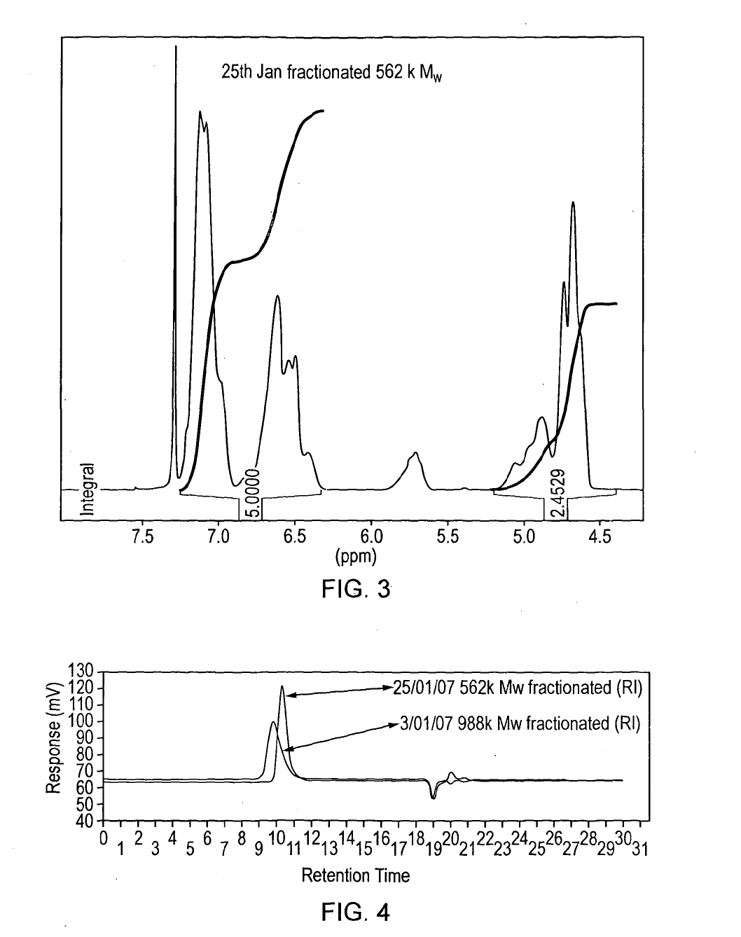

To investigate the internal morphology of these systems small angle x-ray scattering studies were undertaken. The straight line plot in FIG. 2(a) shows the peak optical wavelength for the different blends correlated with the first order scattering peak measured using SAXS. The SAXS measurements were taken using a fixed shear rate that was chosen to give a high degree of order to the system and aid in an accurate determination of the lamellar domain spacing. The shear rate used gave an orientation of the lamellae perpendicular to the surface rather than the parallel orientation necessary for the photonic properties. Studies of the effect of shear on a PS-PI diblock have observed parallel, perpendicular and transverse lamellae as well as disordered structures depending on the type of shear and rate at which it is applied¹⁴.

The data shows a linear increase in peak wavelength as the blend composition is increased in favour of the 988 k BCP diblock.

The domain spacing and peak wavelength for the diblock blends shows an increase as the proportion of higher molecular weight diblock copolymer of the blend is increased. For the block copolymer blends it is observed that an increased lamellar spacing occurs than would be seen for a pure diblock of the same molecular weight.

D=(0.02)·Mₙ^{2/3}

D˜Mₙ^{2/3}

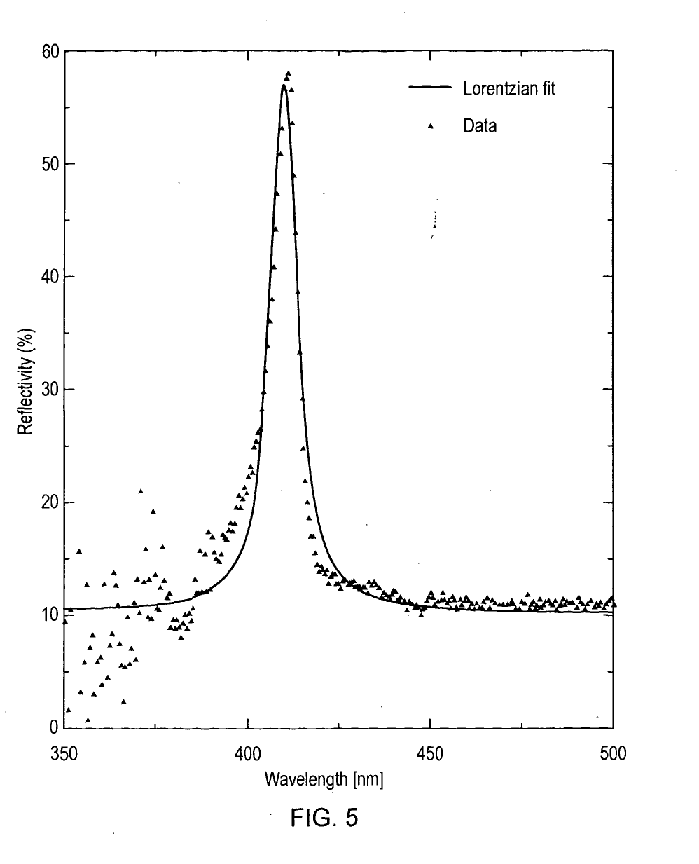

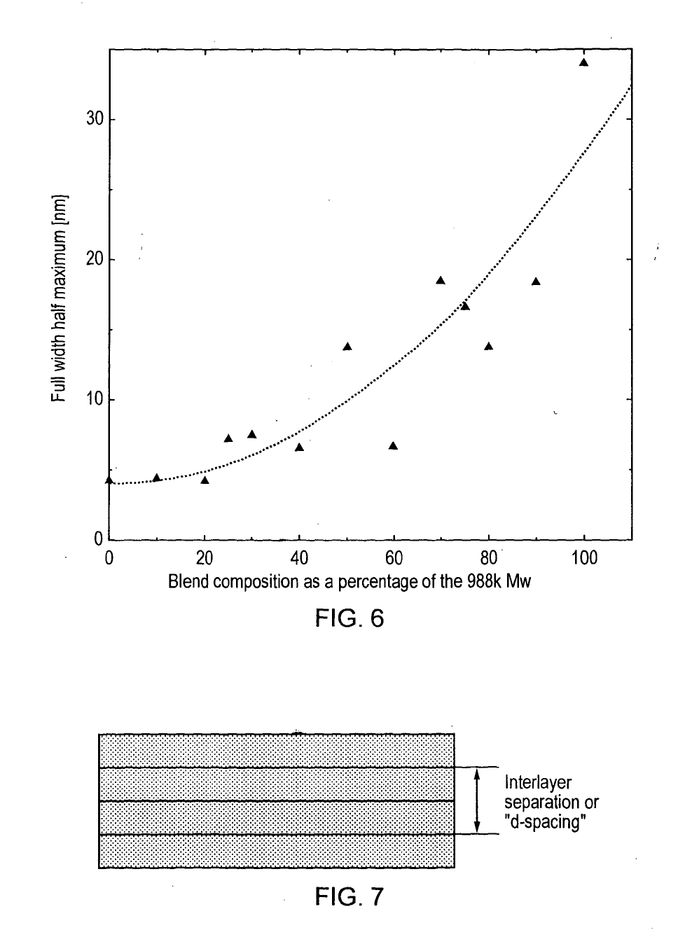

The data in FIGS. 1(b) and 1(c) show that the colour from the lamellar structure is limited to a single lamellar length scale as only one peak is observed in the optical data for each blend composition again confirming the presence of a single structure. The peaks are very narrow for the 562K molecular weight dominated blends; the pure 562K PS-PI sheared layer has a full width half maximum of 8.8 nm showing that the layers are well ordered (see FIG. 5). Plotting the data on a wavelength scale shows a gradual broadening of the peak width (FIG. 6). The broadening effect is less obvious when the data is plotted on an energy (eV) scale as here the peaks are of similar width and equally spaced in energy as the blend composition is altered.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### REFERENCES

1. Deng, T., Chen, C., Honeker, C. & Thomas, E. L. Two-dimensional block copolymer photonic crystals. Polymer 44, 6549 (2003).
2. Fink, Y., Urbas, A. M., Bawendi, M. G., Joannopoulos, J. D. & Thomas, E. L. Block Copolymers as Photonic Bandgap Materials. J. Lightwave Technol. 17, 1963 (1999).
3. Cheng, J. Y., Ross, C. A., Smith, H. I. & Thomas, E. L. Templated Self-Assembly of Block Copolymers: Top-Down Helps Bottom-Up. Adv. Mater. 18, 2505-2521 (2006).
4. Khandpur, A. K. et al. Polyisoprene-Polystyrene Diblock Copolymer Phase Diagram near the Order-Disorder Transition. Macromolecules 28, 8796-8806 (1995).
5. Thomas, E. L. et al. Phase Morphology in Block Copolymer Systems. Philos. T. R. Soc. A 348, 149-166 (1994).
6. Thomas, S. & Prud'homme, R. E. Compatibilizing effect of block copolymers in heterogeneous polystyrene/poly(methyl methacrylate) blends. Polymer 33, 4260-4268 (1992).
7. Jenekhe, S. A. & Chen, X. L. Self-assembly of ordered microporous materials from rod-coil block copolymers. Science 283 (1999).
8. Teraoka, I. Polymer solutions: An introduction to physical properties (Wiley Interscience, New York, 2002).
9. Urbas, A. et al. Adv. Mater. 12, 812-814 (2000).
10. Yamaguchi, D. & Hashimoto, T. A Phase Diagram for the Binary Blends of Nearly Symmetric Diblock Copolymers. 1. Parameter Space of Molecular Weight Ratio and Blend Composition. Macromolecules 34, 6495-6505 (2001).
11. Matsen, M. W. Immiscibility of large and small symmetric diblock copolymers. J. Chem. Phys. 103, 3268-3271 (1995).
12. Iatrou, H. & Hajichristidis, N. Synthesis of a model 3-miktoarm star terpolymer. Macromolecules 25, 4649-4651 (1992).
13. Chen, J. & Fetters, L. J. Anionic polymerization of vinyl monomers. J. Rubber Chem. Technol. 48, 359-409 (1975).
14. Chen, Z. R. et al. Dynamics of Shear-Induced Alignment of a Lamellar Diblock: A Rheo-optical, Electron Microscopy, and X-ray Scattering Study Macromolecules 30, 7096-7114 (1997).

1-24. (canceled)

25. A copolymer film or coating of multilayer light reflective, self-assembling block copolymers comprising a blend of block copolymers of different molecular weight wherein a property of the reflected light is determined by the relative proportions of the respective block copolymers in the blend.

26. The copolymer film or coating according to claim 25, wherein said property of the reflected light is colour, wherein the wavelength of the reflected light is selected in accordance with the relative proportions of the respective block copolymers in the blend from a wavelength range of about 400 nm to about 850 nm.

27. The copolymer film or coating as claimed in claim 25, wherein, for each block copolymer, a first polymer block constituent of the block copolymer differs in refractive index from a second polymer block constituent of that block copolymer.

28. The copolymer film or coating according to claim 25, wherein the block copolymer is selected from block copolymers of C₁₋₆ aliphatic monomers, dienes, C₈₋₁₂ aromatic monomers, block copolymers of polyolefins with vinyl polymers derived from C₁₋₆ aliphatic esters, alcohols, and amines, C₁₋₆ alkylene oxides, and C₇₋₁₂ heterocyclic monomers.

29. The copolymer film or coating according to claim 25, wherein the block copolymer is selected from block copolymers of styrene with methylmethacrylate P(S-b-MMA), isoprene P(S-b-I), butadiene P(S-b-BD), ethylene oxide P(S-b-PEO) and 2-vinylpyridine P(S-b-2-VP), or blends thereof.

30. The copolymer film or coating according to claim 25, wherein the block copolymer blend has an optical domain spacing within the range defined by 400 nm<A <800 nm for visible wavelengths, where λ=2(n₁d₁+n₂d₂), n₁ and n₂ are the refractive indexes of the polymers and d₁ and d₂ are the thicknesses of the domains which make up one lamellar period.

31. The copolymer film or coating according to claim 25, wherein the molecular weights of the block copolymers differ by less than a factor of about 10, optionally by less than a factor of about 5, optionally by less than a factor of about 2.

32. The copolymer film or coating according to claim 25, wherein the film or coating comprises a single lamellar structure substantially without macrophase separation.

33. The copolymer film or coating according to claim 25, wherein the film or coating is semi-transparent.

34. The copolymer film or coating according to claim 25, wherein the copolymers comprising the blend are cross-linked.

35. A method of preparing a multilayer light reflective, self-assembling block copolymer film or coating which reflects light at a desired selected wavelength comprising;
blending first and second block copolymers of different molecular weights and the relative proportions of said block copolymers the blend being selected in accordance with the desired wavelength of reflected or transmitted light.

36. A method of applying an anti-counterfeiting effect to an article or substrate, the method comprising applying to the article or substrate an anti-counterfeiting ink composition or ink-type composition comprising a blend of self-assembling block copolymers of different molecular weight and forming a multilayer light reflective coating or film comprising said blend on the article or substrate, wherein a property of the reflected light is determined by the relative proportions of the respective block copolymers in the blend.

37. The method according to claim 36, wherein the copolymer blend further comprises a cross-linking agent, the method further comprising initiating cross-linking of the copolymers of the blend by the cross-linking agent.

38. A method of determining the colour of light reflected by a light reflective, self assembling block copolymer film or coating comprising a blend of block copolymers, the method comprising preparing a coating mixture comprising a selected blend of two or more block copolymers suitable for forming a said coating;
applying the coating mixture to a substrate to form a said light reflective, self assembling block copolymer film or coating thereon,
directing white light at the coating,
determining the colour of light reflected by the coating, and
recording in human or machine readable format data sufficient to identify the determined colour, in association with the composition of the selected copolymer blend.

39. The method according to claim 38, further comprising the steps of measuring the angle of incidence of light directed at the coating and recording said angle of incidence in association with the measured colour and the composition of the selected polymer blend.

40. The method of according to claim 39, wherein a database is constructed of the colour of light reflected by each of a plurality of light reflective and angle of incidence, self assembling block copolymer films or coatings to identify the measured colour and composition of each respective blend in the database.

41. The method of claim 40, wherein a composition of a copolymer blend associated with said desired colour is identified, preparing a copolymer blend according to said identified blend, and applying said copolymer blend to a substrate to form said coating.
